(19) United States
(12) Patent Application Publication
(10) Pub. No.: US 2025/0019579 A1
(43) Pub. Date: Jan. 16, 2025

(54) COMPOSITION BASED ON (METH)ACRYLATE MONOMERS

(71) Applicants: Bostik SA, COLOMBES (FR); Centre National De La Recherche Scientifique, PARIS (FR); Universite De Haute-Alsace, MULHOUSE CEDEX (FR)

(72) Inventors: Jérôme MAZAJCZYK, VENETTE (FR); Stéphane FOUQUAY, Mont Saint Aignan (FR); Frédéric SIMON, VENETTE (FR); Alexis BARRAT, VENETTE (FR); Jacques LALEVEE, MULHOUSE (FR)

(21) Appl. No.: 18/710,388

(22) PCT Filed: Nov. 18, 2022
(86) PCT No.: PCT/FR2022/000115

§ 371 Date: May 15, 2024

(30) Foreign Application Priority Data
Nov. 22, 2021 (FR) FR2112306

(51) Int. Cl. C09J 133/14; C08F 120/18; C08F 120/28; C09J 5/00; C09J 11/06; C09J 133/10

(52) U.S. Cl. CPC C09J 133/14; C08F 120/18; C08F 120/28; C09J 5/00; C09J 11/06; C09J 133/10

(57) ABSTRACT

The present invention relates to a crosslinkable two-component composition comprising:
a component A comprising:
   a compound having one of the following formulae (Ia) or (Ib):

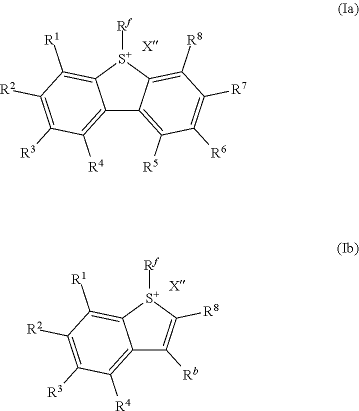

and
   at least one (meth)acrylate monomer M1;
a component B comprising at least one amine compound chosen from polyamines, dihydropyridine compounds, and mixtures thereof;

### FIELD OF THE INVENTION

The present invention relates to a composition based on (meth)acrylate monomer.

The invention also relates to the use of said composition in the repair and/or the semi-structural or structural adhesive bonding of materials in the transportation, marine, assembly, electronics or construction field.

### TECHNOLOGICAL BACKGROUND

Acrylic compositions are known reactive systems which crosslink by radical polymerization. They are used as adhesives, mastics and coatings. Radical polymerization is typically initiated by a redox system which, by means of an oxidation-reduction reaction, results in the production of radicals.

Most acrylic systems are two-component systems. The first component conventionally contains the reducing agent and the reactive monomers, and the second component contains the oxidizing agent. Once the two components have been mixed, the reducing agent induces cleavage of the O—O bond of the organic peroxide for example, and initiates polymerization.

Typically, (meth)acrylic compositions comprise a peroxide (oxidizing agent)/tertiary amine (reducing agent) redox system. However, these systems may present storage stability problems in the presence of (meth)acrylate monomer.

There is a need for novel (meth)acrylic compositions which allow a good compromise between reactivity and storage stability.

In addition, there is also a need for novel (meth)acrylic compositions with good adhesive properties.

### DESCRIPTION OF THE INVENTION

The present invention relates to a crosslinkable two-component composition comprising:
a component A comprising:
   a compound having one of the following formulae (la) or (Ib):

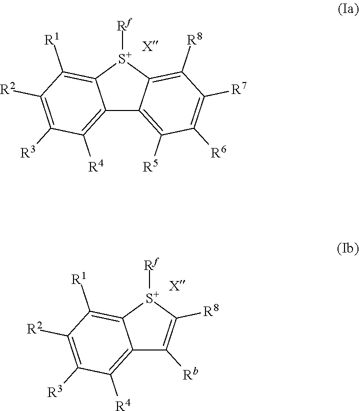

wherein:
   each one among R¹, R², R³, R⁴, R⁵, R⁶, R⁷, R⁸, R^{a} and R^{b} represents, independently of each other, a radical chosen from the group consisting of a hydrogen or halogen atom, alkyl, cycloalkyl or aryl;
   R^{f} represents a perhaloalkyl or a haloalkyl;
   X represents an anion;
and
   at least one (meth)acrylate monomer M1 having one of the formulae (II), (III), (IV) or (V) below:

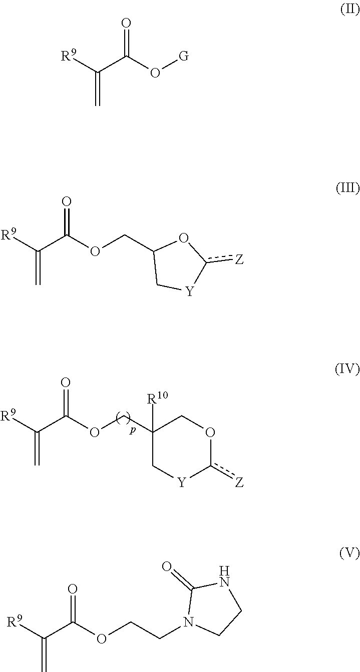

wherein:
   R⁹ represents H or methyl;
   R¹⁰ represents H, methyl or ethyl;
   p represents 0 or 1; and
   Z represents H, O, S, an alkyl group, a benzyl group, an aryl group or an alkoxy group;
   Y represents O, S, NH or CH₂;
   [symbol] is a single bond or a double bond,
   on condition that, when Z represents O, then the bond [symbol] is a double bond;
   G is chosen from the group consisting of C₄ to C₂₀ alkyls, cycloalkyls, alkenyls, cycloalkenyls, alkylaryls, arylalkyls or aryls, said alkyls, cycloalkyls, alkenyls, cycloalkenyls, alkylaryls, arylalkyls and aryls being optionally substituted with an alkyl group, said group G being characterized in that it comprises no heteroatom;
a component B comprising at least one amine compound chosen from polyamines, dihydropyridine compounds, and mixtures thereof
   on condition that, when component A comprises a monomer M1 having the formula (II) and component B comprises an amine compound chosen from dihydropyridine compounds, then component A further comprises an organic or mineral acid having a pKa or a pKa1 ranging from 0.3 to 5.0, measured in water at 25° C.

In the context of the invention, the term “alkyl” is understood to mean a linear or branched hydrocarbon radical preferably comprising from 1 to 20 carbon atoms. Mention may be made, for example, of methyl, ethyl and propyl.

In the context of the invention, the term “C₄ to C₂₀ alkyl” is understood to mean a linear or branched alkyl comprising from 4 to 20 carbon atoms.

In the context of the invention, the term “alkenyl” is understood to mean a linear or branched hydrocarbon radical comprising at least one double bond, said radical preferably comprising from 2 to 20 carbon atoms. By way of example, mention may be made of propenyl, butenyl.

In the context of the invention, the term “alkynyl” means a linear or branched hydrocarbon radical including at least one triple bond, said radical preferably comprising from 2 to 20 carbon atoms.

In the context of the invention, the term “aryl” is understood to mean a monocyclic or bicyclic aromatic radical preferably comprising from 6 to 12 carbon atoms. Mention may be made, for example, of phenyl.

In the context of the invention, the term “arylalkyl” is understood to mean an alkyl group substituted with an aryl group, the arylalkyl group preferably comprising from 7 to 20 carbon atoms. As an arylalkyl group, mention may be made, for example, of benzyl.

In the context of the invention, the term “alkylaryl” means an aryl group substituted with an alkyl group, said alkylaryl group preferably comprising from 7 to 20 carbon atoms.

In the context of the invention, the term “heteroaryl” is understood to mean a monocyclic or bicyclic aromatic radical comprising at least one heteroatom such as for example O, S or N, and preferably comprising from 4 to 12 carbon atoms. Examples that may be mentioned include furanyl, thiophenyl, pyrrolyl, pyridinyl, indolyl or imidazolyl radicals.

In the context of the invention, the term “cycloalkyl” is understood to mean a saturated, monocyclic or polycyclic, preferably monocyclic or bicyclic, system preferably comprising from 3 to 12 carbon atoms, the rings possibly being bridged or fused in pairs, such as the cyclopropyl, cyclopentyl, cyclohexyl or else norbornyl groups.

In the context of the invention, the term “heterocycloalkyl” is understood to mean a saturated, monocyclic or polycyclic, preferably monocyclic or bicyclic, system preferably comprising from 3 to 12 carbon atoms and at least one heteroatom such as for example O or N, the rings possibly being bridged or fused in pairs.

In the context of the invention, the term “cycloalkenyl” means a monocyclic or polycyclic system comprising at least one double bond, preferably including from 3 to 12 carbon atoms, the rings possibly being fused or bridged in pairs.

In the context of the invention, the term “alkoxy” means an —O-alkyl radical.

### Component A

Compound of formula (Ia) or (Ib)

Component A comprises a compound of formula (Ia) or (Ib) as defined above.

The anion X may be chosen from the group consisting of FSO₃⁻, CF₃SO₃⁻, CF₂HSO₃⁻, Cl⁻, Br⁻, BF₄⁻, BF₃Cl⁻, PF₆⁻ and (F₅ Ph)₄B⁻.

In the abovementioned formulae (Ia) or (Ib), R^{f} may represent a haloalkyl. It may, for example, be a fluoroalkyl radical, for instance CHF₂ or CH₂F.

Preferably, in formulae (Ia) or (Ib), R^{f} represents a perfluoroalkyl, and even more preferentially CF₃, C₂F₅, C₃F₇ or C₄F₉. According to a particularly preferred embodiment, R^{f} represents CF₃.

The compound of formula (Ia) or (Ib) may be chosen from those wherein:
each one among R¹, R², R³, R⁴, R⁵, R⁶, R⁷ and R⁸, R^{a} and R^{b} represents, independently of each other, a radical chosen from the group consisting of a hydrogen or halogen atom, or an alkyl, preferably a hydrogen or a fluorine atom;
R^{f} represents a perfluoroalkyl or a fluoroalkyl, preferably a perfluoroalkyl;
X⁻ represents an anion, preferably chosen from FSO₃⁻, CF₃SO₃⁻ and BF₄⁻.

According to a preferred embodiment, component A comprises a compound of formula (Ia), in particular chosen from the group consisting of:

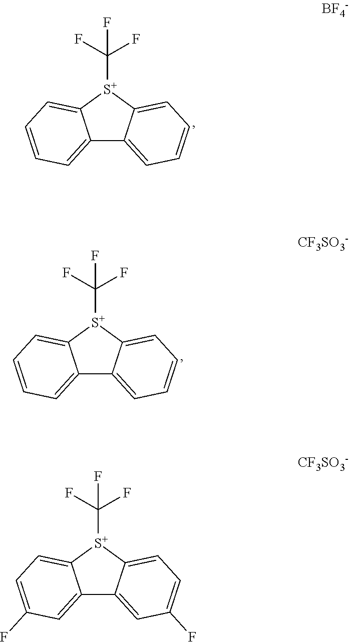 [SMILES: FC(F)(F)[s+]1c2ccccc2c2ccccc21 ; FC(F)(F)[s+]1c2ccccc2c2ccccc21 ; Fc1ccc2c(c1)c1cc(F)ccc1[s+]2C(F)(F)F]

and even more preferentially from one of the following compounds:

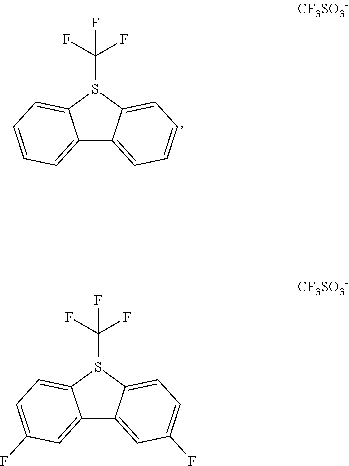 [SMILES: FC(F)(F)[s+]1c2ccccc2c2ccccc21 ; Fc1ccc2c(c1)c1cc(F)ccc1[s+]2C(F)(F)F]

The compounds of formula (Ia) may be prepared as described in WO 2016/107578. The compounds of formula (Ib) may be prepared as described in WO 2011/013307.

The total content of compound(s) of formula (Ia) or (Ib) may range from 0.05% to 5.00% by weight, preferably from 0.10% to 3.00% by weight, even more preferentially from 0.25% to 1.50% by weight relative to the total weight of the crosslinkable two-component composition.

### (Meth)acrylate Monomer M1

Component A comprises at least one (meth)acrylate monomer M1 having one of the formulae (II), (III), (IV) or (V) as defined above;

In the abovementioned formula (II), G is preferably chosen from the group consisting of C₄ to C₂₀ alkyls, cycloalkyls or aryls, said alkyls, cycloalkyls and aryls being optionally substituted with an alkyl group, said group G being characterized in that it does not comprise a heteroatom. Even more preferably, G is chosen from cycloalkyls.

Among the cycloalkyls, mention may be made, for example, of isobornyl, tert-butyl cyclohexyl, trimethylcyclohexyl, dicyclopentenyl and tricyclodecyl.

Among the monomers of formula (II), mention may be made, for example, of 2-ethylhexyl (meth)acrylate, n-butyl (meth)acrylate, heptyl (meth)acrylate, 2-tert-butylheptyl (meth)acrylate, octyl (meth)acrylate, 3-isopropylheptyl (meth)acrylate, nonyl (meth)acrylate, decyl (meth)acrylate, undecyl (meth)acrylate, 5-methylundecyl (meth)acrylate, dodecyl (meth)acrylate, 2-methyldodecyl (meth)acrylate, tridecyl (meth)acrylate, 5-methyltridecyl (meth)acrylate, tetradecyl (meth)acrylate, pentadecyl (meth)acrylate, hexadecyl (meth)acrylate, 2-methylhexadecyl (meth)acrylate, heptadecyl (meth)acrylate, 5-isopropylheptadecyl (meth)acrylate, 4-tert-butyloctadecyl (meth)acrylate, 5-ethyloctadecyl (meth)acrylate, 3-isopropyloctadecyl (meth)acrylate, octadecyl (meth)acrylate, nonadecyl (meth)acrylate, eicosyl (meth)acrylate, bornyl (meth)acrylate, 2,3,4,5-tetra-t-butylcyclohexyl (meth)acrylate; benzyl (meth)acrylate, phenyl (meth)acrylate, 2-(2-ethoxyethoxy)ethyl (meth)acrylate, 2-phenoxyethyl (meth)acrylate, isobornyl (meth)acrylate, and mixtures thereof.

The preferred monomers of formula (II) are the following:

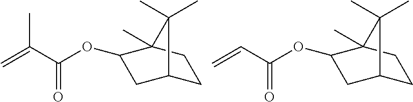

Among the abovementioned monomers M1 of formula (III), mention may be made, for example, of the following monomers:

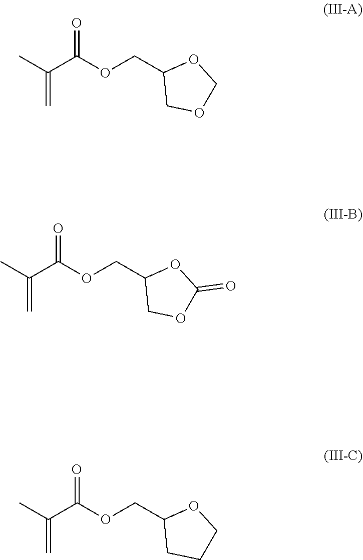

Among the abovementioned monomers M1 of formula (IV), mention may be made, for example, of the following monomers:

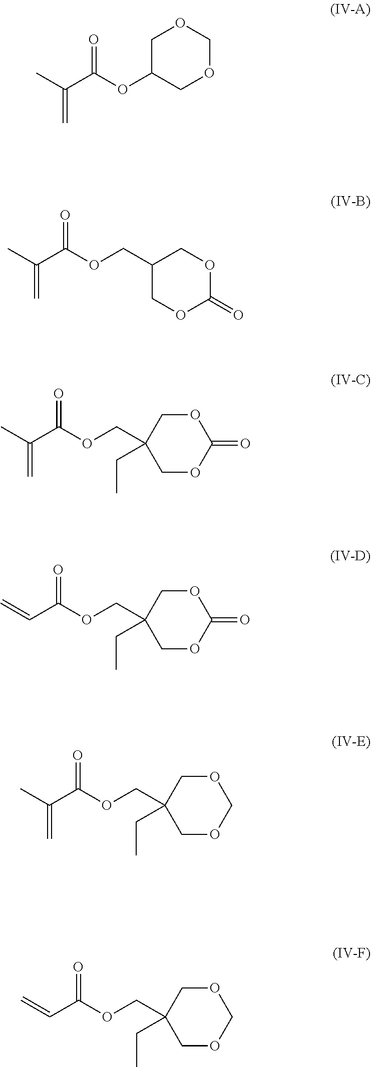 [SMILES: C=C(C)C(=O)OC1COCOC1 ; C=C(C)C(=O)OCC1COC(=O)OC1 ; C=C(C)C(=O)OCC1(CC)COC(=O)OC1 ; C=CC(=O)OCC1(CC)COC(=O)OC1 ; C=C(C)C(=O)OCC1(CC)COCOC1 ; C=CC(=O)OCC1(CC)COCOC1]

Among the monomers M1 of formulae (III) or (IV), the following monomers and mixtures thereof are preferred:

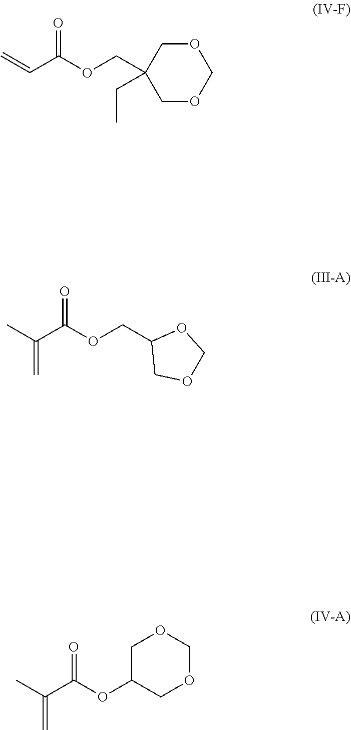

The total content of (meth)acrylate monomer(s) M1 in component A may be greater than or equal to 20% by weight, preferably greater than or equal to 50% by weight, and even more preferentially greater than or equal to 70% by weight relative to the total weight of said component A.

The content of (meth)acrylate monomer(s) M1 in the crosslinkable two-component composition according to the invention may range from 20% to 99% by weight, preferably from 50% to 99% by weight and even more preferentially from 75% to 99% by weight relative to the total weight of said crosslinkable two-component composition.

### Organic or Mineral Acid

When component A comprises a monomer M1 having the abovementioned formula (II), and component B comprises an amine compound chosen from dihydropyridine compounds, in particular dihydropyridines having one of the formulae (VI) to (X) as defined in the present application, then component A further comprises an organic or mineral acid having a pKa or a pKa1 ranging from 0.3 to 5.0, measured in water at 25° C.

When component A comprises a monomer M1 having one of the formulae (III), (IV) or (V), and component B comprises an amine compound chosen from polyamines, then component A preferably further comprises an organic or mineral acid having a pKa or a pKa1 ranging from 0.3 to 5.0, measured in water at 25° C.

The pKa (or acidity constant) is defined by pKa=−log 10 Ka, where Ka is the acid dissociation constant which is measured in the standard manner at 25° C. The standard measurement method recommended for pKa is in particular potentiometry, and more precisely pH-metry, as described for example in Techniques de l'ingénieur [Engineering Techniques] (ref. K695 v1). This method is the most used for the determination of pKa.

The pKa1 is defined by pKa1=−log₁₀ Ka1, where Ka1 is the acid dissociation constant of the first strongest acidity of the polyacids. Ka2 is the acid dissociation constant of the second acidity of the polyacids (where appropriate) and Ka3 is the acid dissociation constant of the third weakest acidity of the polyacids (where appropriate). Each successive acidity of a polyacid pKa1, pKa2 or pKa3 corresponds notably to decreasing values of the acidity constants Ka1, Ka2 and Ka3. The same standard potentiometric measurement indicated previously is used to measure them.

Among the organic acids, mention may be made, for example, of carboxylic acids that are optionally halogenated, phosphorus-based acids, and mixtures thereof.

Among the carboxylic acids that are optionally halogenated, mention may be made, for example, of formic acid, acetic acid, monochloroacetic acid, monofluoroacetic acid, dichloroacetic acid, difluoroacetic acid, propionic acid, malic acid, fumaric acid, malonic acid, succinic acid, maleic acid, fumaric acid, citric acid, acrylic acid, methacrylic acid, cyanoacetic acid, salicylic acid, itaconic acid, benzoic acid, glycolic acid, thioglycolic acid, pyruvic acid, cinnamic acid, and mixtures thereof.

Among the mineral acids, mention may be made, for example, of phosphoric acid, phosphorous acid, methylphosphonic acid, hypophosphorous acid and mixtures thereof.

According to one embodiment, the acid has a pka or pka1 ranging from 2 to 5, and notably from 4 to 5.

According to a preferred embodiment, the acid having a pKa or pka1 ranging from 0.3 to 5 is an organic acid chosen from carboxylic acids that are optionally halogenated, and even more preferentially chosen from acrylic acid, methacrylic acid, itaconic acid, salicylic acid, benzoic acid, monochloroacetic acid, monofluoroacetic acid, dichloroacetic acid, difluoroacetic acid and mixtures thereof. Even more preferably, it is dichloroacetic acid or difluoroacetic acid.

When the two-component composition comprises one or more acids, the total content of acid(s) having a pKa or pKa1 ranging from 0.3 to 5 may range from 0.5% to 20% by weight, preferably from 0.5% to 10% by weight, more preferably from 0.5% to 5%, and even more preferentially from 0.5% to 2% by weight relative to the total weight of the crosslinkable two-component composition according to the invention.

### Photoinitiator P1 (Optional)

Component A may comprise a photoinitiator P1.

The photoinitiator may be any photoinitiator known to those skilled in the art. Under the action of UV/visible radiation, the photoinitiator typically generates radicals which will be responsible for the initiation of the photopolymerization reaction, and makes it possible in particular to increase the efficiency of the photopolymerization reaction. This is, of course, chosen as a function of the light source used, according to its ability to efficiently absorb the radiation selected. It will be possible, for example, to choose the appropriate photoinitiator from its UV/visible absorption spectrum. Advantageously, the photoinitiator is appropriate for working with irradiation sources emitting in the near zone ranging from 300 to 420 nm. Advantageously, the source of UV or visible radiation may be an LED.

The photoinitiator P1 may be chosen from the group consisting of:
type I photoinitiators chosen from:
   the family of acetophenones and alkoxyacetophenones, for instance 2,2-dimethoxy-2-phenylacetophenone and 2-diethyl-2-phenylacetophenone;
   the family of hydroxyacetophenones, for instance 2,2-dimethyl-2-hydroxyacetophenone, 1-hydroxycyclohexyl phenyl ketone, 2-hydroxy-4′-(2-hydroxyethoxy)-2-methylpropiophenone and 2-hydroxy-4′-(2-hydroxypropoxy)-2-methylpropiophenone;
   the family of alkylaminoacetophenones, for instance 2-methyl-4′-(methylthio)-2-morpholinopropiophenone, 2-benzyl-2-(dimethylamino)-4-morpholinobutyrophenone and 2-(4-methylbenzyl)-2-(dimethylamino)-4-morpholinobutyrophenone;
   the family of benzoin ethers, for instance benzyl, benzoin methyl ether and benzoin isopropyl ether;
   the family of phosphine oxides, for instance diphenyl(2,4,6-trimethylbenzoyl) phosphine oxide (TPO), ethyl(2,4,6-trimethylbenzoyl)phenylphosphine oxide (TPO-L) and bis(2,6-dimethoxybenzoyl)-2,4,4-trimethylphenylphosphine oxide (BAPO);
   the family of metallocenes, for instance ferrocene, bis(η5-2,4-cyclopentadien-1-yl)bis(2,6-difluoro)-3-(1H-pyrrol-1-yl)phenyl) titanium and (cumene) (cyclopentadienyl) iron hexafluorophosphate;
type II photoinitiators chosen from:
   the family of benzophenones, for instance 4-phenylbenzophenone, 4-(4′-methylphenylthio)benzophenone or 1-[4-[(4-benzoylphenyl)thio]phenyl]-2-methyl-2-[(4-methylphenyl) sulfonyl]-1-propanone;
   the family of thioxanthones, for instance isopropylthioxanthone (ITX), 2,4-diethylthioxanthone, 2,4-dimethylthioxanthone, 2-chlorothioxanthone and 1-chloro-4-isopropylthioxanthone;
   the family of benzoylformate esters, for instance methyl benzoylformate;
   the family of dibenzylidene ketones, for instance p-dimethylamino ketone;
   the family of coumarins, for instance 5-methoxy- and 7-methoxycoumarin, 7-diethylaminocoumarin and N-phenylglycine coumarin;
photoinitiators of the family of dyes, for instance triazines, fluorones, cyanines, safranins, 4,5,6,7-tetrachloro-3′,6′-dihydroxy-2′,4′,5′,7′-tetraiodo-3H-spiro [isobenzofuran-1,9′-xanthen]-3-one, pyryliums and thiopyryliums, thiazines, flavins, pyronines, oxazines or rhodamines;
and mixtures thereof.

According to a preferred embodiment, the photoinitiator P1 is chosen from:
the family of phosphine oxides, for instance diphenyl(2,4,6-trimethylbenzoyl) phosphine oxide (TPO), ethyl(2,4,6-trimethylbenzoyl)phenylphosphine oxide (TPO-L) and bis(2,6-dimethoxybenzoyl)-2,4,4-trimethylphenylphosphine oxide (BAPO);
the family of thioxanthones, for instance isopropylthioxanthone (ITX), 2,4-diethylthioxanthone, 2,4-dimethylthioxanthone, 2-chlorothioxanthone and 1-chloro-4-isopropylthioxanthone;
the photoinitiator P1 being even more preferentially chosen from diphenyl(2,4,6-trimethylbenzoyl) phosphine oxide (TPO), and ethyl(2,4,6-trimethylbenzoyl)phenylphosphine oxide (TPO-L).

The total content of photoinitiator P1 may range from 0% to 5% by weight, preferably from 0% to 2% by weight, and even more preferentially from 0% to 1% by weight relative to the total weight of the crosslinkable two-component composition according to the invention.

### Component B

Component B comprises at least one amine compound chosen from polyamines, dihydropyridine compounds and mixtures thereof.

### Polyamines

The polyamines may be chosen from:
polyamines comprising at least one primary amine group (—NH₂) (B1);
polyamines not comprising a primary amine group (—NH₂) (B2).

Among the polyamines comprising at least one primary amine group (B1), mention may be made of:
i) aliphatic, cycloaliphatic or arylaliphatic primary diamines, such as for example ethylenediamine (EDA); 2,2-dimethyl-1,3-propanediamine; 1,3-pentanediamine (DAMP); 1,5-pentanediamine; 1,5-diamino-2-methylpentane (MPMD); 2-butyl-2-ethyl-1,5-pentanediamine (C₁₁-neodiamine); 4,4′ diaminodicyclohexyl methane; 2,4′ diaminodicyclohexyl methane; 4,4′ methylenebis(2-methylcyclohexanamine); 1,6-hexanediamine (hexamethylenediamine, HMDA); 2,5-dimethyl-1,6-hexanediamine; 2,2,4- and/or 2,4,4-trimethylhexamethylenediamine; 1,7-heptanediamine; 1,8-octanediamine; 1,9-nonanediamine; 1,10-decanediamine; 1,11-undecanediamine; 1,12-dodecanediamine; 1,2-, 1,3- and 1,4-diaminocyclohexane; bis(4-aminocyclohexyl) methane; bis(4-amino-3-methylcyclohexyl) methane; bis(4-amino-3-ethylcyclohexyl) methane; bis(4-amino-3,5-dimethylcyclohexyl) methane; bis(4-amino-3-ethyl-5-methylcyclohexyl) methane; 1-amino-3-aminomethyl-3,5,5-trimethylcyclohexane (isophorone diamine, IPDA); 2- and/or 4-methyl-1,3-diaminocyclohexane; 1,3-bis(aminomethyl)cyclohexane; 1,4-bis(aminomethyl)cyclohexane; 2,5 (2,6)-bis(aminomethyl)-bicyclo[2.2.1]heptane (norborane diamine, NBDA); 3(4),8(9)-bis(aminomethyl)tricyclo[5.2.1.0^{2,6}]decane (TCD-diamine); 1,4-diamino-2,2,6-trimethylcyclohexane (TMCDA); 1,8-menthanediamine; 3,9-bis(3-aminopropyl)-2,4,8,10-tetraoxaspiro[5.5]undecane; 1,3-bis(aminomethyl)benzene (m-XDA), and mixtures thereof;
(ii) primary diamines comprising at least one secondary amine group (—NHR, with R other than H) such as, for example, 3-(2-aminoethyl)aminopropylamine, bis(hexamethylene)triamine (BHMT); diethylenetriamine (DETA); triethylenetetramine (TETA); tetraethylenepentamine (TEPA); pentaethylenehexamine (PEHA); and mixtures thereof;
iii) aromatic polyamines such as, for example, 2,4-tolylenediamine (2,4-TDA); 2,6-tolylenediamine (2,6-TDA); m-phenylenediamine (PDA); 4,4′-diaminodiphenylmethane (4,4′-MDA); 2,4′-diaminodiphenylmethane (2,4′-MDA); and mixtures thereof;
iv) polyamines comprising a tertiary amine group (—NR₂, R being other than H) and at least two primary amine groups (—NH₂) such as, for example, N,N′-bis(aminopropyl) piperazine; N,N-bis(3-aminopropyl)methylamine; N,N-bis(3-aminopropyl)ethylamine; N,N-bis(3-aminopropyl) propylamine; N,N-bis(3-aminopropyl)cyclohexylamine; N,N-bis(3-aminopropyl)-2-ethylhexylamine; tris(2-aminoethyl)amine; tris(2-aminopropyl)amine; tris(3-aminopropyl)amine; and mixtures thereof;
(v) polyetheramines, in particular polyetherdiamines such as, for example, bis(2-aminoethyl) ether; 3,6-dioxaoctane-1,8-diamine; 4,7-dioxadecane-1,10-diamine; 4,7-dioxadecane-2,9-diamine; 4,9-dioxadodecane-1,12-diamine; 5,8-dioxadodecane-3,10-diamine; 4,7,10-trioxatridecane-1,13-diamine; bis(3-aminopropyl) polytetrahydrofurans; and mixtures thereof;

vi) polyamines comprising a primary amine group (—NH₂) and a secondary amine group (—NHR, R being other than H) such as, for example, N-butyl-1,2-ethanediamine; N-hexyl-1,2-ethanediamine; N-cyclohexyl-1,2-ethanediamine; 4-aminomethylpiperidine; N-(2-aminoethyl) piperazine; N-methyl-1,3-propanediamine; N-butyl-1,3-propanediamine; N-(2-ethylhexyl)-1,3-propanediamine; N-cyclohexyl-1,3-propanediamine; 3-methylamino-1-pentylamine; 3-ethylamino-1-pentylamine; 3-cyclohexylamino-1-pentylamine; and mixtures thereof;
vii) amino alcohols such as, for example, aminoethylethanolamine (AEEA);
viii) polyamidoamines;
ix) fatty amine dimers or trimers;
x) polyethyleneimines (and dendrimers thereof) such as, for example, those having a number-average molecular mass (Mn) ranging from 450 to 25 000 g/mol and having in particular at least one radical of the following formula:

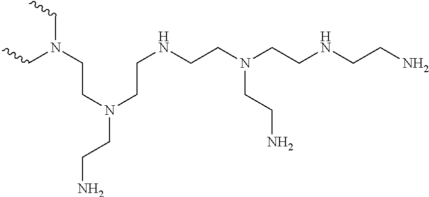

(mention may be made, for example, of the polyethyleneimines sold under the name Lupasol sold by BASF);
xi) polypropyleneimines (and dendrimers thereof);
xii) poly(propylene-ethylene)imines;
xiii) and mixtures thereof.

The polyamines (B1) are preferably chosen from
i) aliphatic, cycloaliphatic or arylaliphatic primary diamines;
ii) primary diamines comprising at least one secondary amine group (—NHR, with R other than H);
x) polyethyleneimines (and dendrimers thereof);
and mixtures thereof.

Among the polyamines not comprising a primary amine group (B2), mention may be made, for example, of polyamines comprising one or more secondary amine groups (—NHR, R being other than H) and/or one or more tertiary amine groups (—NR₂, R being other than H).

The polyamines B2 may be chosen from the group consisting of N,N,N′,N′-tetraalkyl alkylenediamines, such as, for example, N,N,N′,N′-tetramethylethylenediamine (TEMED, CAS No.: 110-18-9), N,N,N′,N′-tetramethyl-2,2′-oxybis(ethylamine) (CAS No.: 3033-62-3), N,N,N′,N′-tetramethyltrimethylenediamine (CAS No.: 110-95-2) and N,N,N′,N′-tetramethylhexamethylenediamine (CAS No.: 111-18-2).

When the amine compound is a polyamine, then the total content of polyamine(s) may range from 0.2% to 5.0% by weight, preferably from 0.3% to 3.0% by weight, and even more preferentially from 0.4% to 1.5% by weight relative to the total weight of the crosslinkable two-component composition according to the invention.

### Dihydropyridine Compound

The dihydropyridine compounds are preferably chosen from the dihydropyridines of formulae (VI) to (X) below:

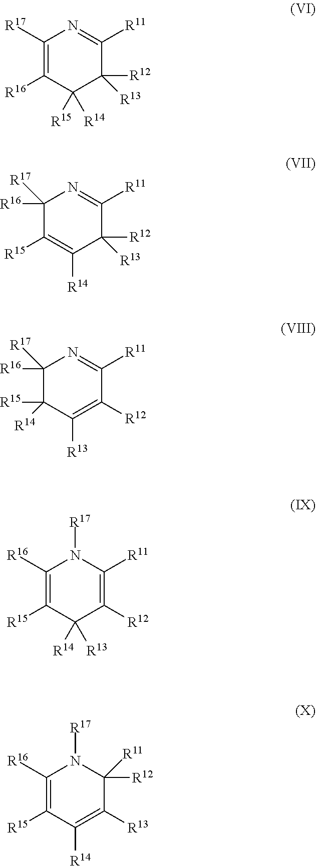

wherein:
   each of the radicals R¹¹ to R¹⁷ represents, independently of each other, a hydrogen, an alkyl, an alkenyl, an alkynyl, a cycloalkyl, a heterocycloalkyl, a heteroaryl, an aryl, an alkylaryl, an arylalkyl, a radical —COOR^{c};
   said alkyl, alkenyl, alkynyl, cycloalkyl, heterocycloalkyl, heteroaryl, aryl, alkylaryl and arylalkyl groups being optionally substituted; and R^{c} represents an alkyl or aryl radical;
   or two radicals from among R¹¹ to R¹⁷ together form an optionally substituted monocyclic or polycyclic ring.

The dihydropyridine compound may be chosen from those of formulae (VI) to (X) wherein:
R¹⁷ represents an aryl or heteroaryl, said aryl or heteroaryl being optionally substituted, and
R¹¹ to R¹⁶ represents, independently of each other, a hydrogen, an alkyl, an alkenyl, an alkynyl, a cycloalkyl, a heterocycloalkyl, a heteroaryl, an aryl, an alkylaryl, an arylalkyl, a radical —COOR^{a}, R^{a} representing an alkyl;
R¹¹ to R¹⁶ preferably representing, independently of each other, a hydrogen or an alkyl or a radical —COOR^{c} with R^{c} representing an alkyl.

According to a preferred embodiment, the dihydropyridine compound has the formula (VI) or (VII) as defined previously.

The dihydropyridine compound may be chosen from the following compounds:

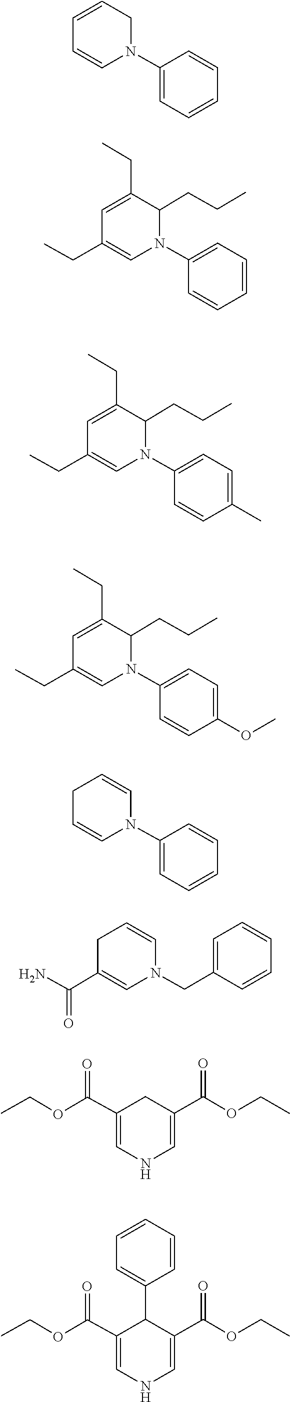

According to a preferred embodiment, the dihydropyridine is the following compound:

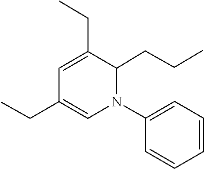 [SMILES: CCCC1C(CC)=CC(CC)=CN1c1ccccc1]

The dihydropyridines may be commercially available, for instance Vanax 808 HP sold by Vanderbilt Chemicals, or may be synthesized as described, for example, in WO 2006/086602.

When the amine compound is a dihydropyridine compound, then the total content of dihydropyridine compound(s), having in particular one of the formulae (VI) to (X) as defined above may range from 0.25% to 5.0% by weight, preferably from 0.3% to 3.0% by weight, and even more preferentially from 0.4% to 1.5% by weight relative to the total weight of the crosslinkable two-component composition according to the invention.

### Monomers

Component B may comprise one or more (meth)acrylate monomer(s) M1 having one of the formulae (II), (III), (IV) or (V) as defined for component A.

Preferably, component B comprises the same (meth)acrylate monomer M1 as in component A.

Component B may comprise more than 50% by weight of monomer(s) M1, preferably more than 70% by weight, and even more preferentially more than 90% by weight, relative to the total weight of said component B.

Component B may in particular comprise from 60% to 99.9% by weight of monomer(s) M1, and preferably from 80% to 99.5% by weight, relative to the total weight of said component B.

### Composition

The crosslinkable two-component composition according to the invention may comprise at least one additive chosen from the group consisting of catalysts, fillers, antioxidants, light stabilizers/UV absorbers, metal deactivators, antistatic agents, film-preventing agents, foaming agents, biocides, plasticizers, lubricants, emulsifiers, dyes, pigments, rheological agents, impact modifiers, adhesion promoters, accelerators, optical brighteners, flame retardants, anti-sweating agents, nucleating agents, solvents, and mixtures thereof.

These additives can be present in component A and/or component B of the composition according to the invention.

By way of example of an accelerator, saccharin may be mentioned, for example.

As examples of plasticizers that may be used, mention may be made of any plasticizer normally used in the field of adhesives, for instance epoxy resins, phthalates, benzoates, trimethylolpropane esters, trimethylolethane esters, trimethylolmethane esters, glycerol esters, pentaerythritol esters, naphthenic mineral oils, adipates, cyclohexyldicarboxylates, paraffinic oils, natural oils (optionally epoxidized), polypropylenes, polybutylenes, hydrogenated polyisoprenes, and mixtures thereof.

Use may be made, for example, of:
diisodecyl phthalate, as sold, for example, under the name Palatinol™ DIDP by BASF,
an ester of alkylsulfonic acid and of phenol, as sold, for example, under the name Mesamoll® by Lanxess,
diisononyl 1,2-cyclohexanedicarboxylate, as sold, for example, under the name Hexamoll Dinch® by BASF,
pentaerythrityl tetravalerate, as sold, for example, under the name Pevalen™ by Perstorp,
the epoxidized soya bean oil as sold, for example, under the name Vikoflex® 7170 by Arkema.

As examples of (thixotropic) rheological agent(s) that may be used, mention may be made of any rheological agent customarily used in the field of adhesive compositions.

Preferably, the thixotropic agents are chosen from:
PVC plastisols, corresponding to a suspension of PVC in a plasticizing agent which is miscible with PVC, obtained in situ by heating to temperatures ranging from 60° C. to 80° C. These plastisols may be those described in particular in the publication “Polyurethane Sealants”, Robert M. Evans, ISBN 087762-998-6,
fumed silica, as sold, for example, under the name HDK® N20 by Wacker;
urea derivatives resulting from the reaction of an aromatic diisocyanate monomer, such as 4,4′-MDI, with an aliphatic amine, such as butylamine. The preparation of such urea derivatives is described in particular in the application FR 1 591 172;
micronized amide waxes, such as Crayvallac® SLT or Crayvallac® SLA sold by Arkema.

The composition according to the invention may also comprise at least one organic and/or mineral filler.

The mineral filler(s) that may be used is (are) advantageously chosen so as to improve the mechanical performance of the composition according to the invention in the crosslinked state.

As examples of mineral filler(s) that may be used, use may be made of any mineral filler(s) usually used in the field of adhesive compositions. These fillers are typically in the form of particles of diverse geometry. They may be, for example, spherical or fibrous or may have an irregular shape.

Preferably, the filler(s) is (are) chosen from the group consisting of clay, quartz, carbonate fillers, kaolin, gypsum, clays and mixtures thereof; preferentially, the filler(s) is (are) chosen from carbonate fillers, such as alkali metal or alkaline-earth metal carbonates, and more preferentially calcium carbonate or chalk.

These fillers can be untreated or treated, for example treated using an organic acid, such as stearic acid, or a mixture of organic acids predominantly consisting of stearic acid.

Use may also be made of hollow mineral microspheres, such as hollow glass microspheres, and more particularly of those made of calcium sodium borosilicate or of aluminosilicate.

The composition according to the invention may also comprise at least one adhesion promoter, preferably chosen from silanes, such as aminosilanes, epoxysilanes or acryloyl silanes, or adhesion promoters based on a phosphate ester, such as for example the 2-hydroxyethyl methacrylate phosphate ester, 2-methacryloyloxyethyl phosphate, bis(2-methacryloyloxyethyl phosphate), 2-acryloyloxyethyl phosphate, bis(2-acryloyloxyethyl phosphate), methyl-(2-methacryloyloxyethyl phosphate), ethyl-(2-methacryloyloxyethyl phosphate), a mixture of 2-hydroxyethyl methacrylate mono- and diphosphate esters.

When a pigment is present in the composition, its content is preferably less than or equal to 3% by weight, more preferably less than or equal to 2% by weight, relative to the total weight of the composition. When it is present, the pigment can, for example, represent from 0.1% to 3% by weight or from 0.4% to 2% by weight, of the total weight of the composition. The pigments may be organic or inorganic pigments.

For example, the pigment is TiO₂, in particular Kronos® 2059 sold by Kronos.

The composition can comprise an amount of from 0.1% to 3%, preferably from 1% to 3%, by weight of at least one UV stabilizer or antioxidant. These compounds are typically introduced to protect the composition from degradation resulting from a reaction with oxygen which is liable to be formed by the action of heat or light. These compounds may include primary antioxidants which trap free radicals. The primary antioxidants may be used alone or in combination with other secondary antioxidants or UV stabilizers.

Mention may be made, for example, of Irganox® 1010, Irganox® B561, Irganox® 245, Irgafos® 168, Tinuvin® 328 or Tinuvin™ 770, which are sold by BASF.

According to a preferred embodiment, the two-component composition according to the invention does not comprise any peroxide.

In the composition according to the invention, the component A/component B volume ratio may range from 20/1 to 1/1, preferentially from 10/1 to 1/1.

### B. Ready-to-Use Kit

The present invention also relates to a ready-to-use kit, comprising both component A as defined above and component B as defined above, packaged in two separate compartments. It can, for example, be a two-component cartridge.

Indeed, the composition according to the invention can be in a two-component form, for example within a ready-to-use kit, comprising both component A in a first compartment or drum and component B in a second compartment or drum, in proportions suitable for direct mixing of the two components, for example using a metering pump.

According to one embodiment of the invention, the kit additionally comprises one or more means for mixing components A and B. Preferably, the mixing means are chosen from metering pumps or static mixers with a diameter suited to the amounts used.

### C. Uses of the Composition

The present invention also relates to the use of a crosslinkable two-component composition as defined above as adhesive, mastic or coating, preferably as adhesive.

The invention also relates to the use of said composition in the repair and/or the structural or semi-structural adhesive bonding of materials in the transportation, motor vehicle (car, bus or truck), assembly, marine, electronics or construction field.

The present invention relates to a process for assembling two substrates by adhesive bonding, involving:
coating, onto at least one of the two substrates to be assembled, a composition obtained by mixing components A and B as defined above; and then
bringing the two substrates into effective contact;
crosslinking the composition.

The crosslinking step can be carried out at a temperature of between 0° C. and 200° C., preferably between 10° C. and 150° C., preferably between 23° C. and 80° C. and in particular between 20° C. and 25° C.

The appropriate substrates are, for example, inorganic substrates, such as concrete, metals or alloys (such as aluminum alloys, steel, non-ferrous metals and galvanized metals); or else organic substrates, such as wood, plastics, such as PVC, polycarbonate, PMMA, polyethylene, polypropylene, polyesters, epoxy resins; substrates made of metal and composites coated with paint.

The crosslinking may be performed under electromagnetic irradiation, for instance with a UV radiation source or an LED. Electromagnetic irradiation may be performed on the adhesive bonding wafers in the case of an opaque substrate, or directly through the substrate in the case of a transparent substrate.

The crosslinking step under electromagnetic irradiation may be performed at a wavelength greater than 300 nm, preferably ranging from 360 nm to 680 nm, and even more preferentially from 360 nm to 420 nm.

The compositions according to the invention are advantageously stable on storage.

The compositions according to the invention advantageously allow a good compromise between stability on storage and high reactivity.

The compositions according to the invention advantageously exhibit, after crosslinking, good adhesive properties.

In addition, the surface of the crosslinked compositions advantageously dries rapidly and may be tack-free, thereby notably making it possible to increase the productivity of industrial processes.

All the embodiments described above may be combined with each other. In particular, the various abovementioned constituents of the composition, and notably the preferred embodiments of the composition, may be combined with each other.

In the context of the invention, the term “of between x and y” or “ranging from x to y” is understood to mean an interval within which the limits x and y are included. For example, the range “between 0% and 25%” notably includes the values 0% and 25%.

The invention is now described in the following implementation examples, which are given purely by way of illustration and should not be interpreted in order to limit the scope thereof.

### EXAMPLES

The following ingredients were used:
SR® 506 D: isobornyl acrylate (IBOA) (CAS No.: 5888-33-5) sold by Arkema;
SR® 531: cyclic trimethylolpropane formal acrylate (CAS No.: 66492-51-1) sold by Arkema;
Vanax® 808 HP: 3,5-diethyl-1,2-dihydro-1-phenyl-2-propylpyridine (CAS No.: 34562-31-7) sold by Vertellus Specialties;
Difluoroacetic acid (CAS No.: 381-73-7) available from Sigma-Aldrich;
Thiophenium III: 5-(trifluoromethyl)dibenzothiophenium, 1,1,1-trifluoromethanesulfonate (CAS: 129946-88-9) available from Sigma-Aldrich;
Thiophenium I: 2,8-difluoro-5-trifluoromethyldibenzothiophenium 1,1,1 trifluoromethanesulfonate (CAS: 1961266-44-3) available from TCI chemicals;
DETA: diethylenetriamine (DETA) (CAS No.: 111-40-0) available from Huntsman.

### Example 1: Preparation of Composition No. 1 (According to the Invention)

The ingredients of component A are mixed in the proportions shown in the following table, at a temperature of 23° C., in a continuously stirred mixer and under air.

The various ingredients constituting component B are mixed in the proportions shown in the following table, at a temperature of 23° C., in a continuously stirred mixer and under air.

Composition 1 according to the invention

| Component A | | Component B | |
|---|---|---|---|
| | % by weight | | % by weight |
| | (relative to the | | (relative to the |
| Ingredients | total weight of A) | Ingredients | total weight of B) |
| Thiophenium | 1% | Vanax ® 808 HP | 1% |
| III | | | |
| SR ® 531 | 99% | SR ® 531 | 99% |
| TOTAL | 100 | TOTAL | 100 |

Component A and component B are mixed, in a volume ratio of 1:1 using a Sulzer® Mixpac mixer at ambient temperature of 23° C.

### Example 2: Preparation of Composition No. 2 (According to the Invention)

The ingredients of component A are mixed in the proportions shown in the following table, at a temperature of 23° C., in a continuously stirred mixer and under air.

The various ingredients constituting component B are mixed in the proportions shown in the following table, at a temperature of 23° C., in a continuously stirred mixer and under air.

Composition No. 2 according to the invention

| Component A | | Component B | |
|---|---|---|---|
| | % by weight | | % by weight |
| | (relative to the | | (relative to the |
| Ingredients | total weight of A) | Ingredients | total weight of B) |
| Thiophenium I | 2% | DETA | 2% |
| Difluoroacetic acid | 2% | SR ®531 | 98% |
| SR ®531 | 96% | | |
| TOTAL | 100 | TOTAL | 100 |

Component A and component B are mixed, in a volume ratio of 1:1 using a Sulzer® Mixpac mixer at ambient temperature of 23° C.

### Example 3: Preparation of Composition No. 3 (According to the Invention)

The ingredients of component A are mixed in the proportions shown in the following table, at a temperature of 23° C., in a continuously stirred mixer and under air.

The various ingredients constituting component B are mixed in the proportions shown in the following table, at a temperature of 23° C., in a continuously stirred mixer and under air.

Composition No. 3 according to the invention

| Component A | | Component B | |
|---|---|---|---|
| | % by weight | | % by weight |
| | (relative to the | | (relative to the |
| Ingredients | total weight of A) | Ingredients | total weight of B) |
| Thiophenium I | 2% | DETA | 2% |
| SR ® 506 D | 98% | SR ® 506 D | 98% |
| TOTAL | 100 | TOTAL | 100 |

Component A and component B are mixed, in a volume ratio of 1:1 using a Sulzer® Mixpac mixer at ambient temperature of 23° C.

### Example 4: Performance of the Compositions

### Reactivity Measurement:

The exotherm is analyzed continuously using a pyrometer and by thermal imaging.

The peak time is the time required to reach the peak temperature (maximum exotherm observed during polymerization), unlike the gel time (or lag time), which is the time it takes for the sample to start polymerizing.

The time/temperature profiles were produced using an Omega OS552-V1-6 industrial infrared thermometer (Omega Engineering®, Inc., Stamford, CT) accurate to +1° C. for 2 g (about 4.0 mm height) and 0.25 g (1.4 mm height) of polymerization.

### Adhesive Bonding Test:

Application of composition No. 1 or No. 2 or No. 3 (obtained, respectively, in examples 1, 2, 3 by mixing components A and B using a Sulzer® Mixpac mixer) on a first glass microscope slide (25×76 mm);
Affixing a second glass microscope slide (25×76 mm) onto the first slide which received composition No. 1, No. 2 or No. 3.
Step of sliding the two microscope slides to enable equal distribution of composition No. 1, No. 2 or No. 3 between the two slides (the oxygen exposure is reduced here).

The time from which it is no longer possible to separate the two slides is recorded; this is the adhesive bonding time.

| | | Temperature | Adhesive | |
|---|---|---|---|---|
| | Peak time | peak | bonding | |
| Composition | (s) | (in ° C.) | time in (s) | Comments |
| Composition No. 1 | 24 | 150 | 30 | No tack |
| (example 1) | | | | |
| Composition No. 2 | 22 | 95 | 45 | No tack |
| (example 2) | | | | |
| Composition No. 3 | 34 | 75 | 150 | No tack |
| (example 3) | | | | |

As emerges from this table, compositions No. 1, No. 2 and No. 3 (according to the invention) advantageously polymerize quickly (after mixing components A and B), in view of their short peak times (24, 22 and 34 seconds, respectively).

In addition, compositions No. 1 and No. 2 and No. 3 advantageously lead to adhesive bonding having fast setting times.

Finally, it was observed that the polymer obtained after crosslinking is advantageously dry at the surface (tack free).

1-17. (canceled)

18. A crosslinkable two-component composition comprising:
a component A comprising:
a compound having one of the following formulae (Ia) or (Ib): 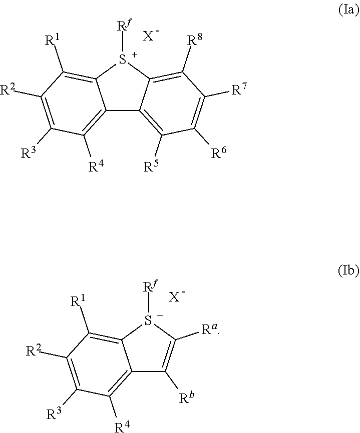
wherein:
each one among R¹, R², R³, R⁴, R⁵, R⁶, R⁷, R⁸, R^{a} and R^{b} represents, independently of each other, a radical chosen from the group consisting of a hydrogen or halogen atom, alkyl, cycloalkyl or aryl;
R^{f} represents a perhaloalkyl or a haloalkyl;
X⁻ represents an anion;
and
at least one (meth)acrylate monomer M1 having one of the following formulae (II), (III), (IV) or (V): 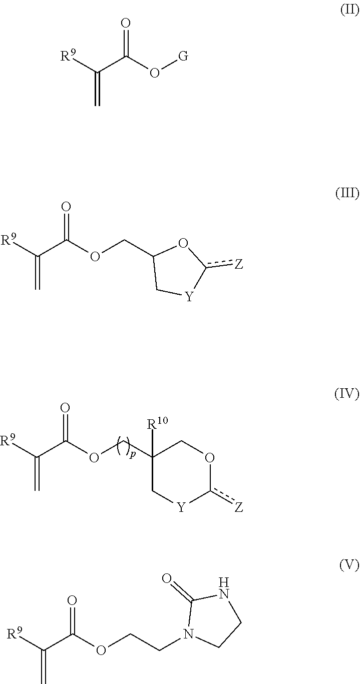
wherein:
R⁹ represents H or methyl;
R¹⁰ represents H, methyl or ethyl;
p represents 0 or 1; and
Z represents H, O, S, an alkyl group, a benzyl group, an aryl group or an alkoxy group;
Y represents O, S, NH or CH₂; [symbol]
is a single bond or a double bond,
on condition that, when Z represents O, then the bond [symbol] is a double bond;
G is chosen from the group consisting of C₄ to C₂₀ alkyls, cycloalkyls, alkenyls, cycloalkenyls, alkylaryls, arylalkyls or aryls, said alkyls, cycloalkyls, alkenyls, cycloalkenyls, alkylaryls, arylalkyls and aryls being optionally substituted with an alkyl group, said group G being characterized in that it comprises no heteroatom;
a component B comprising at least one amine compound chosen from polyamines, dihydropyridine compounds, and mixtures thereof
wherein, when component A comprises a monomer M1 having the formula (II) and component B comprises an amine compound chosen from dihydropyridine compounds, then component A further comprises an organic or mineral acid having a pKa or a pKa1 ranging from 0.3 to 5.0, measured in water at 25° C.

19. The composition as claimed in claim 18, characterized in that, in formula (Ia) or (Ib), the anion X⁻ is chosen from the group consisting of FSO₃⁻, CF₃SO₃⁻, CF₂HSO₃⁻, Cl⁻, Br⁻, BF₄⁻, BF₃Cl⁻, PF₆⁻ and (F₅Ph)₄B⁻.

20. The composition as claimed in claim 18, characterized in that, in formula (Ia) or (Ib):
each one among R¹, R², R³, R⁴, R⁵, R⁶, R⁷, and R⁸ represents, independently of each other, a radical chosen from the group consisting of a hydrogen or halogen atom, or an alkyl;
R^{f} represents a perfluoroalkyl or a fluoroalkyl;
X⁻ represents an anion.

21. The composition as claimed in claim 18, characterized in that the compound of formula (Ia) is chosen from the group consisting of:

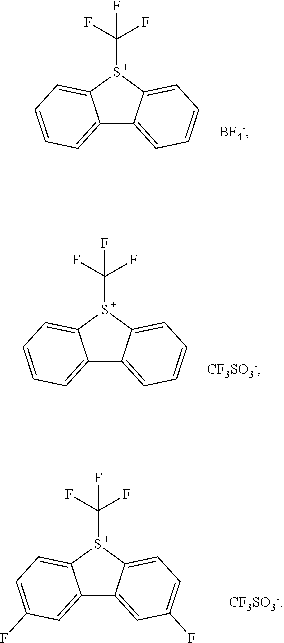

22. The composition as claimed in claim 18, characterized in that in formula (II), G is chosen from the group consisting of C₄ to C₂₀ alkyls, cycloalkyls or aryls, said alkyls, cycloalkyls and aryls being optionally substituted with an alkyl group, said group G being characterized in that it does not comprise a heteroatom.

23. The composition as claimed in claim 18, characterized in that, in formula (II), G is chosen from cycloalkyls.

24. The composition as claimed in claim 18, characterized in that the monomer M1 of formula (III) is chosen from the following monomers:

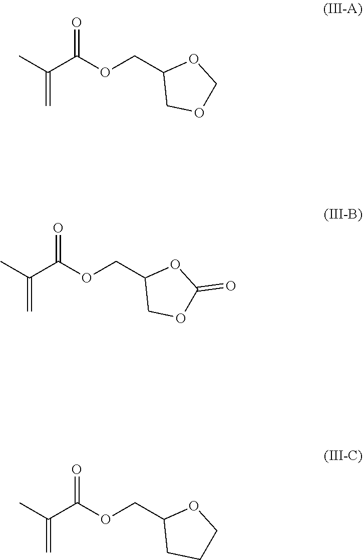

25. The composition as claimed in claim 18, characterized in that the monomer M1 of formula (IV) is chosen from the following monomers:

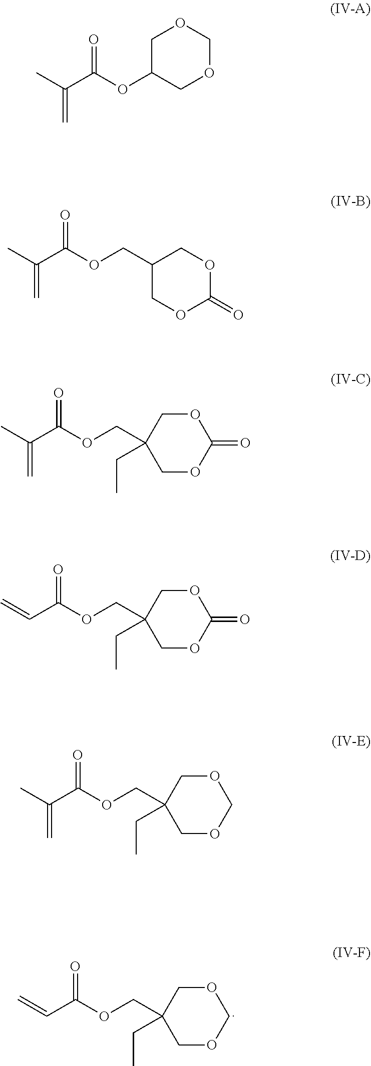 [SMILES: C=C(C)C(=O)OC1COCOC1 ; C=C(C)C(=O)OCC1COC(=O)OC1 ; C=C(C)C(=O)OCC1(CC)COC(=O)OC1 ; C=CC(=O)OCC1(CC)COC(=O)OC1 ; C=C(C)C(=O)OCC1(CC)COCOC1 ; C=CC(=O)OCC1(CC)COCOC1]

26. The composition as claimed in claim 18, characterized in that the content of (meth)acrylate monomer(s) M1 in the crosslinkable two-component composition ranges from 20% to 99% by weight, relative to the total weight of said crosslinkable two-component composition.

27. The composition as claimed in claim 18, characterized in that the polyamines are chosen from:
polyamines comprising at least one primary amine group (—NH₂) (B1); and
polyamines not comprising a primary amine group (—NH₂) (B2).

28. The composition as claimed in claim 27, characterized in that the polyamines comprising at least one primary amine group (B1) are chosen from:
i. aliphatic, cycloaliphatic or arylaliphatic primary diamines;
ii. primary diamines comprising at least one secondary amine group (—NHR, with R other than H);
iii. aromatic polyamines;
iv. polyamines comprising a tertiary amine group (—NR₂, R being other than H) and at least two primary amine groups (—NH₂);
V. polyetheramines;
vi. amino alcohols;
vii. polyamidoamines;
viii. fatty amine dimers or trimers;
ix. polyethyleneimines (and dendrimers thereof);
X. polypropyleneimines (and dendrimers thereof);
xi. poly(propylene-ethylene)imines;
xii. and mixtures thereof.

29. The composition as claimed in claim 27, characterized in that the polyamines (B1) are chosen from:
i. aliphatic, cycloaliphatic or arylaliphatic primary diamines;
ii. primary diamines comprising at least one secondary amine group (—NHR, with R other than H);
iii. polyethyleneimines (and dendrimers thereof);
and mixtures thereof.

30. The composition as claimed in claim 18, characterized in that the dihydropyridine compound has one of the following formulae (VI) to (X): 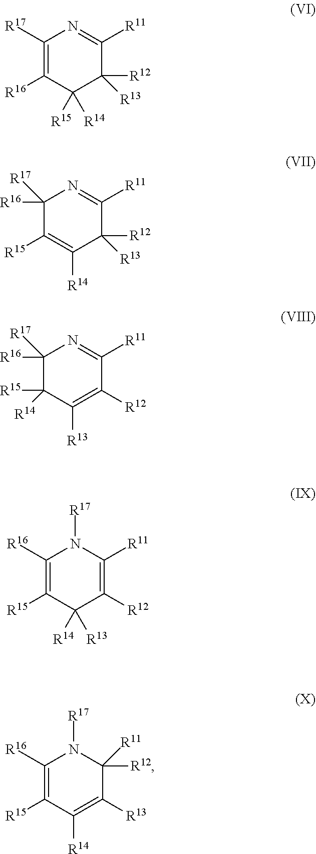
wherein:
each of the radicals R¹¹ to R¹⁷ represents, independently of each other, a hydrogen, an alkyl, an alkenyl, an alkynyl, a cycloalkyl, a heterocycloalkyl, a heteroaryl, an aryl, an alkylaryl, an arylalkyl, a radical —COOR^{c}; said alkyl, alkenyl, alkynyl, cycloalkyl, heterocycloalkyl, heteroaryl, aryl, alkylaryl and arylalkyl groups being optionally substituted; and R^{c} represents an alkyl or aryl radical;
or two radicals from among R¹¹ to R¹⁷ together form an optionally substituted monocyclic or polycyclic ring.

31. The composition as claimed in claim 18, characterized in that the dihydropyridine compound is chosen from the following compounds:

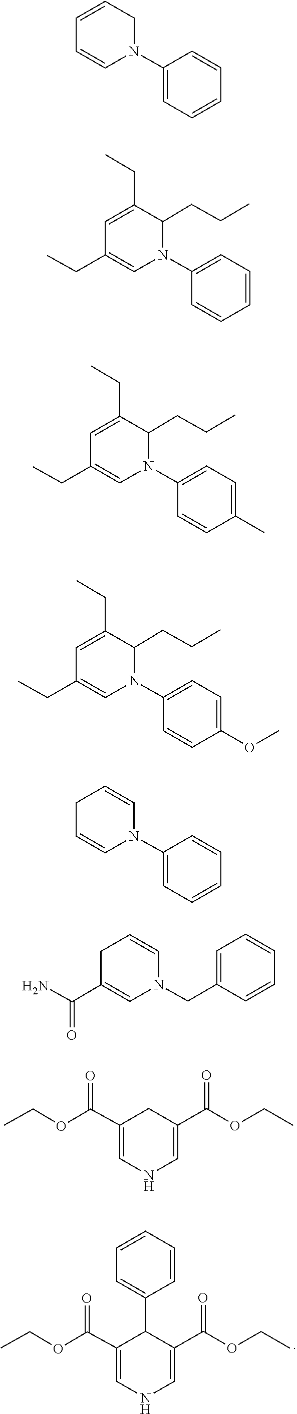

32. The composition as claimed in claim 18, characterized in that the acid having a pKa or pka1 ranging from 0.3 to 5 is an organic acid chosen from carboxylic acids.

33. An adhesive, mastic, or coating comprising the composition as defined in claim 18.

34. A process for assembling two substrates by adhesive bonding, comprising:
coating at least one of the two substrates to be assembled with the composition as defined in claim 18; and then
bringing the two substrates into effective contact; and
crosslinking the composition.

35. The composition as claimed in claim 23, characterized in that, in formula (II), G is chosen from the following:

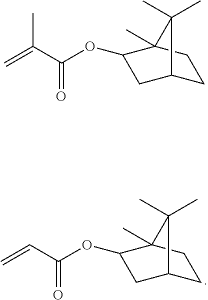 [SMILES: C=C(C)C(=O)OC1CC2CCC1(C)C2(C)C ; C=CC(=O)OC1CC2CCC1(C)C2(C)C]

36. The composition as claimed in claim 18, characterized in that the acid having a pKa or pka1 ranging from 0.3 to 5 is an organic acid chosen from acrylic acid, methacrylic acid, itaconic acid, salicylic acid, benzoic acid, monochloroacetic acid, monofluoroacetic acid, dichloroacetic acid, difluoroacetic acid and mixtures thereof.

37. The composition as claimed in claim 28, characterized in that the polyamines comprising at least one primary amine group (B1) are chosen from:
i. ethylenediamine (EDA); 2,2-dimethyl-1,3-propanediamine; 1,3-pentanediamine (DAMP); 1,5-pentanediamine; 1,5-diamino-2-methylpentane (MPMD); 2-butyl-2-ethyl-1,5-pentanediamine (C₁₁-neodiamine); 4,4′ diaminodicyclohexyl methane; 2,4′ diaminodicyclohexyl methane; 4,4′ methylenebis(2-methylcyclohexanamine); 1,6-hexanediamine (hexamethylenediamine, HMDA); 2,5-dimethyl-1,6-hexanediamine; 2,2,4- and/or 2,4,4-trimethylhexamethylenediamine; 1,7-heptanediamine; 1,8-octanediamine; 1,9-nonanediamine; 1,10-decanediamine; 1,11-undecanediamine; 1,12-dodecanediamine; 1,2-, 1,3- and 1,4-diaminocyclohexane; bis(4-aminocyclohexyl) methane; bis(4-amino-3-methylcyclohexyl) methane; bis(4-amino-3-ethylcyclohexyl) methane; bis(4-amino-3,5-dimethylcyclohexyl) methane; bis(4-amino-3-ethyl-5-methylcyclohexyl) methane; 1-amino-3-aminomethyl-3,5,5-trimethylcyclohexane (isophorone diamine, IPDA); 2- and/or 4-methyl-1,3-diaminocyclohexane; 1,3-bis(aminomethyl)cyclohexane; 1,4-bis(aminomethyl)cyclohexane; 2,5 (2,6)-bis(aminomethyl)-bicyclo[2.2.1]heptane (norborane diamine, NBDA); 3 (4),8 (9)-bis(aminomethyl) tricyclo[5.2.1.0^{2,6}]decane (TCD-diamine); 1,4-diamino-2,2,6-trimethylcyclohexane (TMCDA); 1,8-menthanediamine; 3,9-bis(3-aminopropyl)-2,4,8,10-tetraoxaspiro[5.5]undecane; 1,3-bis(aminomethyl)benzene (m-XDA), and mixtures thereof;
ii. 3-(2-aminoethyl)aminopropylamine, bis(hexamethylene)triamine (BHMT); diethylenetriamine (DETA); triethylenetetramine (TETA); tetraethylenepentamine (TEPA); pentaethylenehexamine (PEHA); and mixtures thereof;
iii. 2,4-tolylenediamine (2,4-TDA); 2,6-tolylenediamine (2,6-TDA); m-phenylenediamine (PDA); 4,4′-diaminodiphenylmethane (4,4′-MDA); 2,4′-diaminodiphenylmethane (2,4′-MDA); and mixtures thereof;
iv. N,N′-bis(aminopropyl) piperazine; N,N-bis(3-aminopropyl)methylamine; N,N-bis(3-aminopropyl)ethylamine; N,N-bis(3-aminopropyl) propylamine; N,N-bis(3-aminopropyl)cyclohexylamine; N,N-bis(3-aminopropyl)-2-ethylhexylamine; tris(2-aminoethyl)amine; tris(2-aminopropyl)amine; tris(3-aminopropyl)amine; and mixtures thereof;
v. bis(2-aminoethyl) ether; 3,6-dioxaoctane-1,8-diamine; 4,7-dioxadecane-1,10-diamine; 4,7-dioxadecane-2,9-diamine; 4,9-dioxadodecane-1,12-diamine; 5,8-dioxadodecane-3,10-diamine; 4,7,10-trioxatridecane-1,13-diamine; bis(3-aminopropyl) polytetrahydrofurans; and mixtures thereof;
vi. N-butyl-1,2-ethanediamine; N-hexyl-1,2-ethanediamine; N-cyclohexyl-1,2-ethanediamine; 4-aminomethylpiperidine; N-(2-aminoethyl) piperazine; N-methyl-1,3-propanediamine; N-butyl-1,3-propanediamine; N-(2-ethylhexyl)-1,3-propanediamine; N-cyclohexyl-1,3-propanediamine; 3-methylamino-1-pentylamine; 3-ethylamino-1-pentylamine; 3-cyclohexylamino-1-pentylamine; and mixtures thereof;
vii. aminoethylethanolamine (AEEA);
viii. polyamidoamines;
ix. fatty amine dimers or trimers;
x. polyethyleneimines having a number-average molecular mass (Mn) ranging from 450 to 25,000 g/mol;
xi. polypropyleneimines (and dendrimers thereof);
xii. poly(propylene-ethylene)imines;
xiii. and mixtures thereof.
